(19) United States
(12) Patent Application Publication
(10) Pub. No.: US 2009/0183534 A1
(43) Pub. Date: Jul. 23, 2009

(54) LANYARD WITH COUPLER

(75) Inventor: Michael Brojanac, Jackson, WI (US)

Correspondence Address: CALFEE, HALTER & GRISWOLD LLP, 1400 KEYBANK CENTER, 800 SUPERIOR AVENUE, CLEVELAND, OH, 44114, US

(73) Assignee: MASTER LOCK COMPANY LLC, Oak Creek, WI (US)

(21) Appl. No.: 12/017,555

(22) Filed: Jan. 22, 2008

(51) Int. Cl. E05B 73/00

(52) U.S. Cl. 70/15

(57) ABSTRACT

A lanyard includes a tether that can be connected to a catch to secure a lock mechanism to a surface located in proximity to a lock receiving interface that is configured to receive the lock mechanism. The lock mechanism is thus maintained near the lock receiving interface when the lock mechanism is not received in the lock receiving interface. The lock mechanism can include, for example, a padlock or a hasp.

### FIELD OF THE INVENTION

The present invention relates generally to a lanyard for installing locks and hasps to a storage enclosure.

### BACKGROUND OF THE INVENTION

Storage enclosures are used to enclose, store and secure various types of goods and materials. Storage enclosures may include a variety of spaces, such as for example, toolboxes, lockers, garages, sheds and gated areas. A common way to secure a storage enclosure is with a padlock. Industrial machinery often includes a machine lock out switch that disables the machinery during repairs and maintenance. A tradesman who is repairing the machine may insert a hasp through the lock out switch or a lock out switch enclosure to maintain the switch in the locked out position. The hasp is locked with a padlock or other lock to which only the tradesman working on the machinery has the key. Some hasps include multiple locations for padlocks so that the machinery can be locked out by multiple tradesmen working on the machinery. In this manner, the tradesman may prevent operation of the machinery while it is in an unsafe condition.

### SUMMARY OF THE INVENTION

An adjustable length lanyard is configured to be mounted on a mounting surface near a lock receiving interface. The lanyard is connected to a lock mechanism that includes a mounting orifice. The lanyard secures the lock mechanism to the mounting surface. The lanyard includes a flexible tether, a catch that retains the tether, and a lock mechanism coupler configured to be snap fit into the mounting orifice. The lock mechanism may include, for example, a padlock or a hasp.

Further features and advantages of the invention will become apparent from the following detailed description made with reference to the accompanying drawings.

### BRIEF DESCRIPTION OF THE DRAWINGS

In the accompanying drawings, which are incorporated in and constitute a part of this specification, embodiments of the invention are illustrated, which, together with the description of the invention serve to illustrate the principles of this invention. The drawings and detailed description are not intended to and do not limit the scope of the invention or any subsequent claims in any way. Instead, the drawings and description only describe embodiments of the invention and other embodiments of the invention not described are encompassed by this disclosure of the invention.

FIG. 1 is a perspective view of lanyard including a catch, a tether, and two collars, constructed according to an embodiment of the present invention;

FIG. 1A is a perspective view of lanyard including a catch, a tether, and a hasp coupler, constructed according to an embodiment of the present invention;

FIGS. 2A-2D are schematic illustrations the lanyard of FIG. 1 being installed on a mounting surface;

FIG. 3 is a schematic illustration of the lanyard of FIG. 1 securing a lock out hasp;

FIG. 4 is a rear view of the catch of FIG. 1;

FIG. 5 is a cross section view of the catch of FIG. 1;

FIG. 6 is a perspective view of a clip that is part of the catch of FIG. 1;

FIG. 7 is a perspective view of the collar shown in FIG. 1;

FIG. 8 is an exploded component level view of a lanyard including a catch, a tether, and a hasp coupler; and

FIG. 9 is a front view of the lanyard of FIG. 8 as assembled.

### DETAILED DESCRIPTION OF THE INVENTION

This Detailed Description of the Invention merely describes embodiments of the invention and is not intended to limit the scope of the claims in any way. Indeed, the invention as described in the claims is broader than and unlimited by the preferred embodiments, and the terms used in the claims have their full ordinary meaning.

The present invention will be described with use on a storage enclosure having a door and a machine having a lockable lock out switch. It should be understood that this is for exemplary purposes only and the invention can be applied to a wide variety of applications.

As discussed in the background above, there are numerous situations in which a lock mechanism such as a padlock or hasp is used to secure a lock receiving interface associated with a particular enclosure or lock out switch. While the lock mechanism is not in use, it may be misplaced, causing inconvenience and delay. Therefore, it is considered advantageous to provide the ability to stow the lock mechanism in proximity to the lock receiving interface so that it can be readily located when needed.

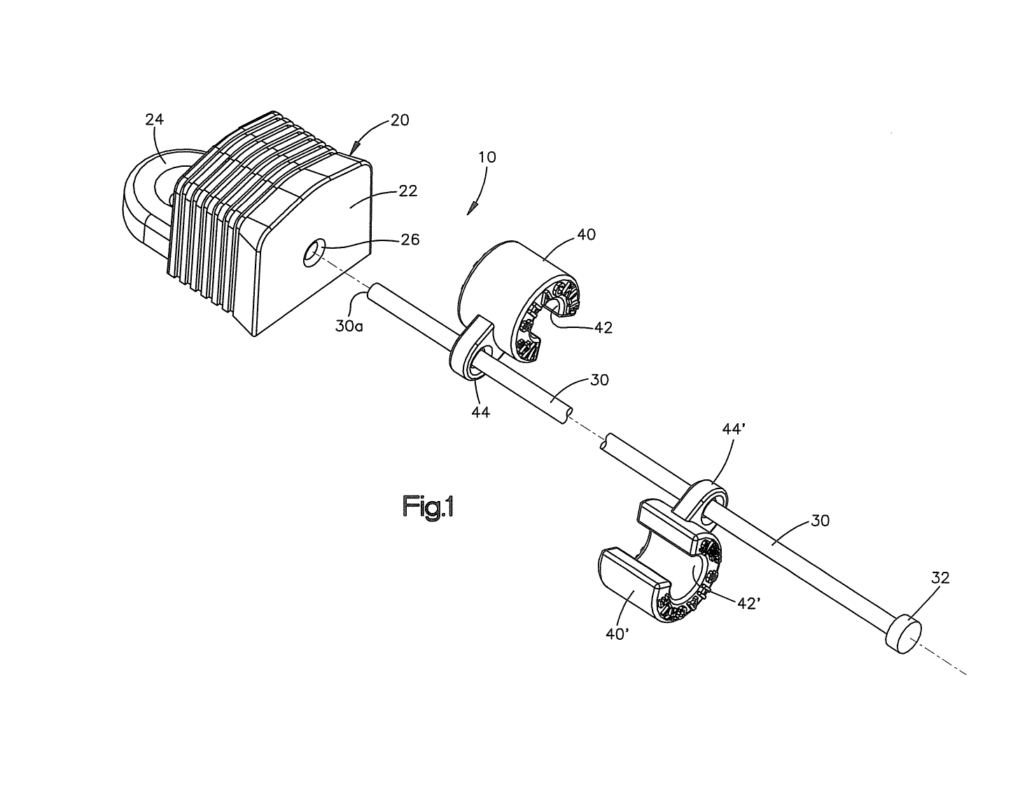

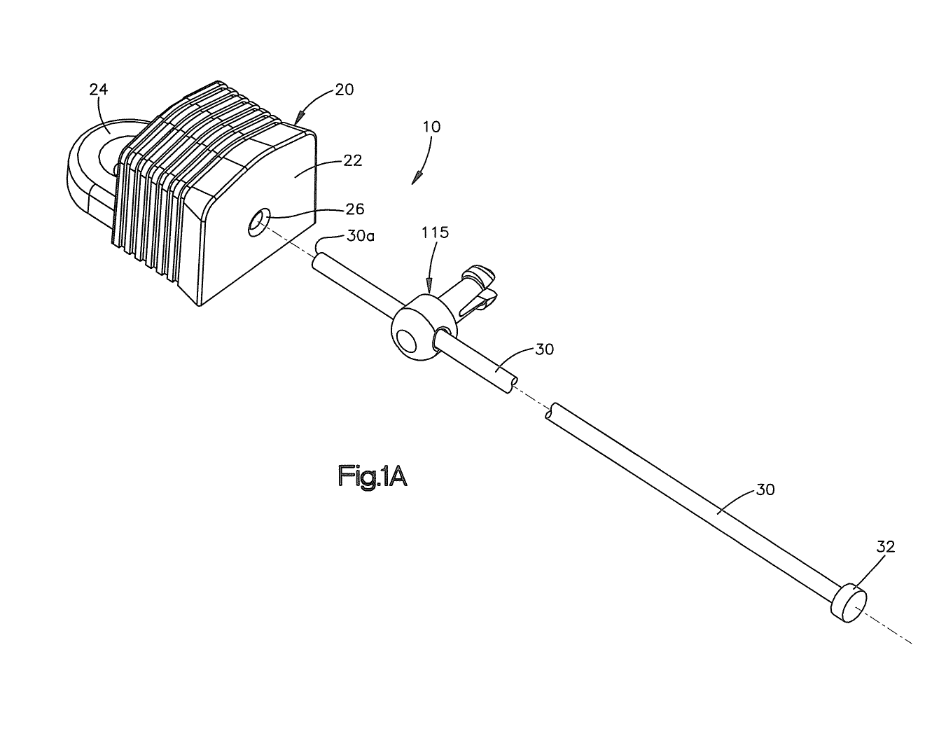

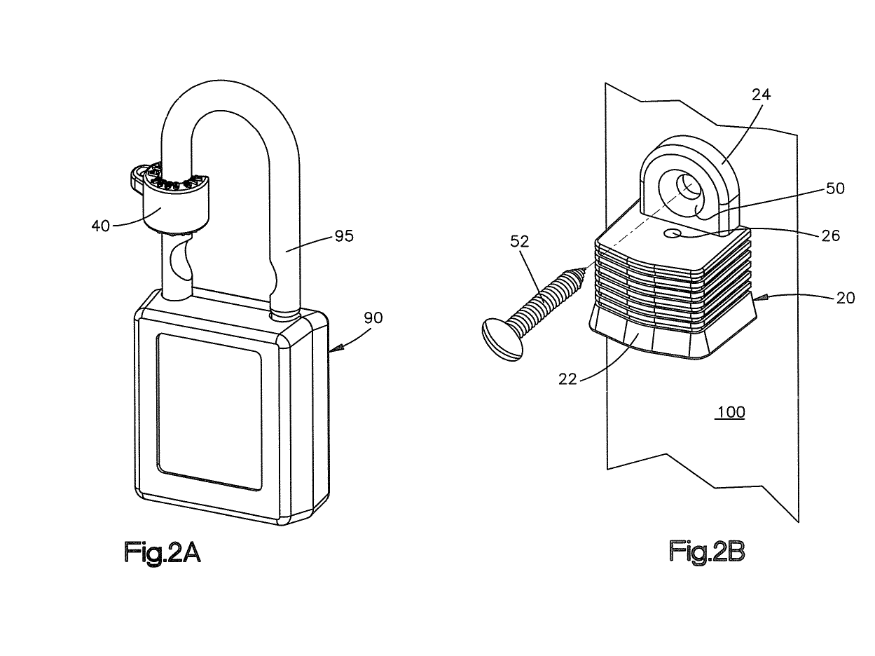

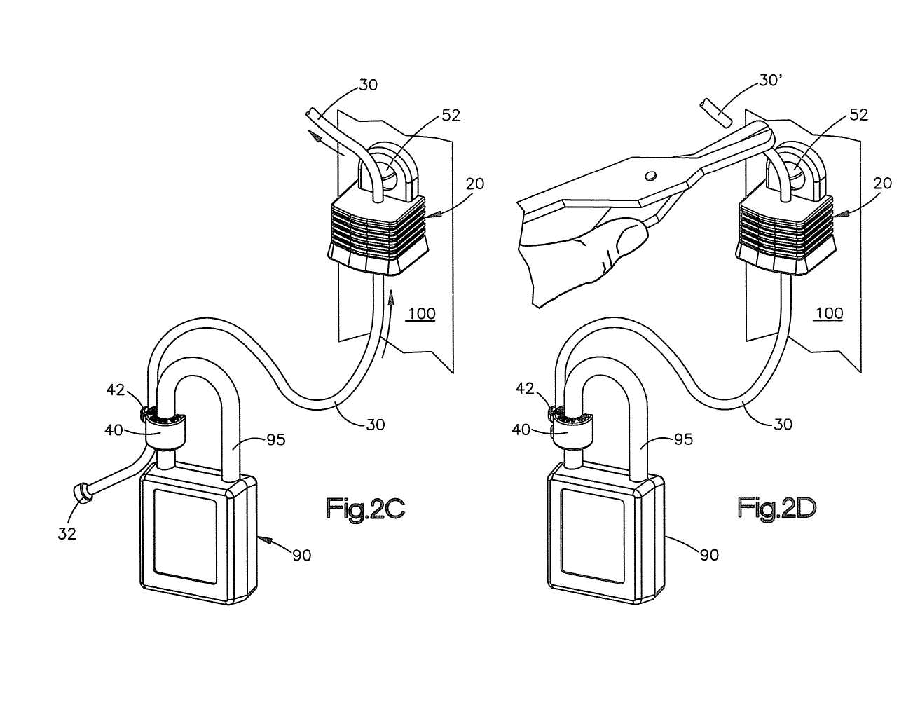

FIG. 1 illustrates a lanyard 10 that can be used to secure a lock mechanism such as a padlock or hasp to a mounting surface 100 (FIG. 2D) in proximity to a lock receiving interface such as a hasp on an enclosure or a lock out switch on a machine. The lanyard 10 includes a catch 20, a tether 30, and one or more optional collars 40. The catch 20 includes a housing 22 that is molded from, for example, plastic. An inner channel 26 extends through the housing 22 and has a size and shape that permits the tether 30 to be inserted into the channel. A mounting ear 24 is disposed at a top of the catch 20 through which a fastener 52 may be installed to mount the catch to the mounting surface. Of course, other mounting mechanisms such as, for example, adhesive or a pair of complimentary mechanical features on the catch and mounting surface may be used to mount the catch to the mounting surface.

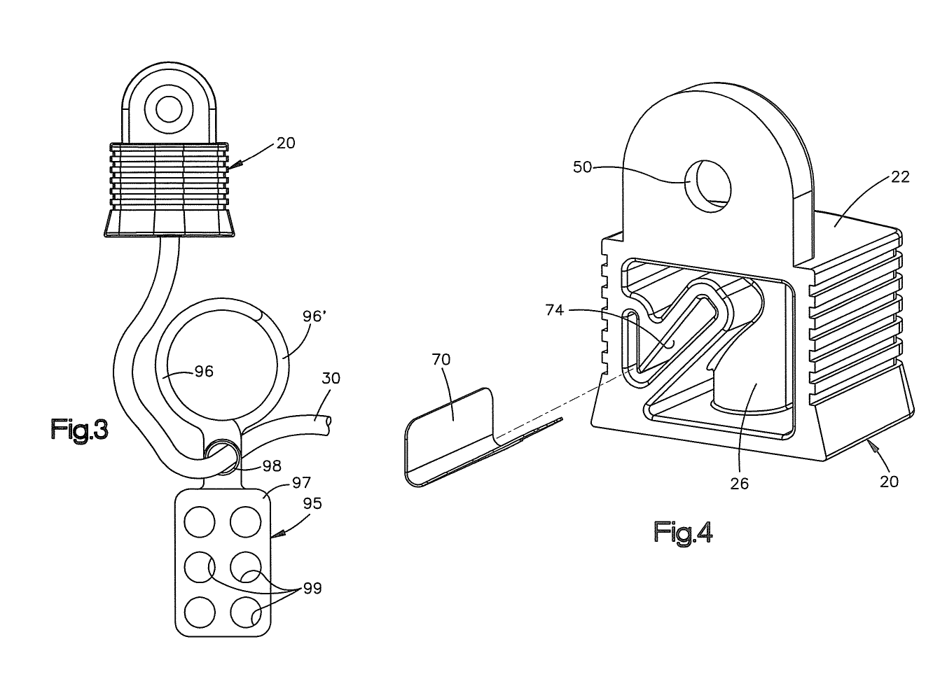

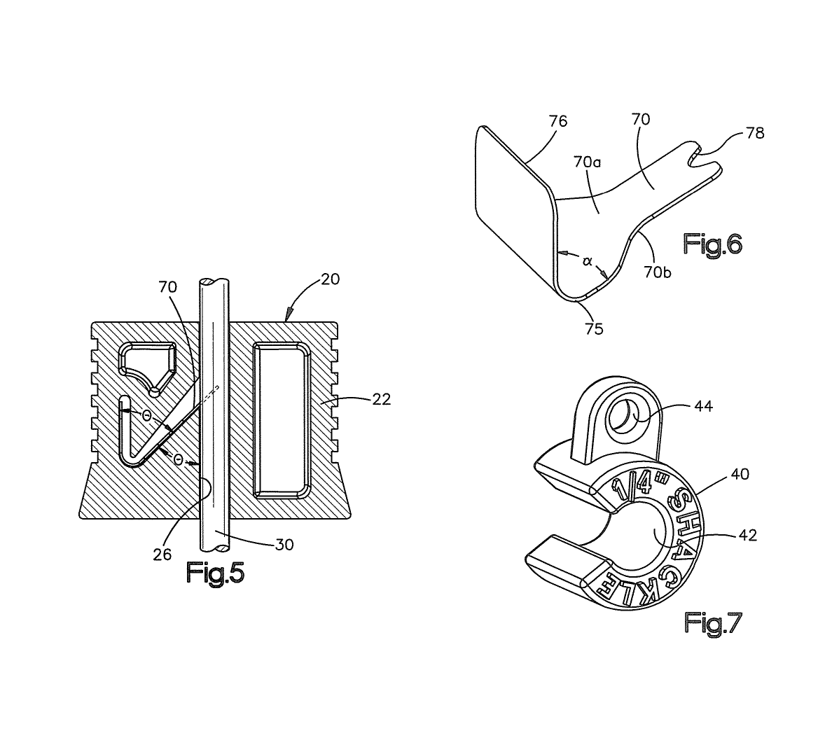

The tether 30 has an adjustable length. For example, the tether may be molded from plastic such that it can be severed by household scissors. Other materials that could be used to fashion the adjustable length tether could be rope, wire, or a chain with removable links. A tether head 32 is molded or otherwise connected to a distal end of the tether. The tether head 32 has a larger diameter than the rest of the tether and is sized to prevent a collar 40 or hasp 95 (FIG. 3) from sliding off the distal end of the tether. The collars 40, shown in more detail in FIG. 7, include a mounting tab 44 that has an opening sized to thread around the tether 30 but be retained by the tether head 32. A lock mechanism retainer 42, in the embodiment shown, has a C-shape and is configured to snap fit around a shackle on a padlock 90 as shown in FIG. 2A. Other retainer configurations 42 could be employed that conveniently fit around other locking mechanisms. As shown in FIG. 1, two collars 40, 40′ may be threaded onto the tether. The collars may be of identical configuration, or, as shown in FIG. 1, the collars 40 may include retainers 42, 42′ having different sizes to fit around different sized locking mechanisms. While the exemplary retainer 42 shown in FIG. 7 has a ¼ inch inner diameter, any inner diameter size could be employed. The dimensions of the retainer 42 may be embossed or otherwise indicated on the retainer for convenience. The lanyard 10 may also be used without any collars as shown in FIG. 3.

FIGS. 2A-2D illustrate the lanyard 10 as used to secure the padlock 90 to the mounting surface 100, such as an enclosure that is to be locked. The collar 40 is snapped around a shackle 95 of the padlock in FIG. 2A using the retainer 42. In FIG. 2B, the catch 20 is mounted to the mounting surface 100 by inserting a fastener 52 through the mounting ear 24 and fastening the fastener 52 to the mounting surface 100. In FIG. 2C, the tether 30 is threaded through the mounting tab 44 on the collar 40 and then through the housing inner channel 26 (FIG. 1). As will be described in more detail in connection with FIG. 4, the catch 20 includes internal features that allow movement of the tether in the direction indicated by the arrows in FIG. 2C while greatly impeding movement of the tether in a direction opposite from the direction indicated by the arrows in FIG. 2C. In FIG. 2D, once the length of the tether 30 remaining below the catch 20 is acceptable, the user may sever an excess portion 30′ of the tether that extends out of the top of the catch.

FIG. 3 illustrates an exemplary lanyard that can be used to secure a machine lock out hasp 95 to a piece of machinery. The hasp 95 includes two pivoting fingers 96, 96′ that pivot about an open pivot connector 98. The tether 30 is threaded through the pivot connector 98 and then through the catch as described above. The tether head 42 is too large to slide through the pivot connector 98. The hasp is thus secured to the machinery on the tether 30 between the catch 20 and the tether head 32. The hasp is thereby made conveniently available for a tradesman who wants to lock out the machine for repairs or maintenance. The hasp's fingers 96, 96′ are each fixed to a corresponding lock engaging plate 97 (lock engaging plate 97′ that corresponds to finger 96′ is not visible in FIG. 3). To lock out the piece of machinery, a tradesman places the hasp fingers 96, 96′ through two openings (not shown): one opening on the machinery's power switch or a latch on a power switch enclosure that prevents access to the power switch and another opening that is fixed in position with respect to the machinery. Thus, when the two openings are fixed together, the lockable power switch cannot be actuated. The fingers 96, 96′ are held in a closed position when the tradesman inserts a padlock through a hole 99 in the plates 97, 97′ to fix them together. Multiple holes are provided so that multiple tradesman can lock out the same piece of machinery, thus securing the machinery until all the tradesman have completed their work.

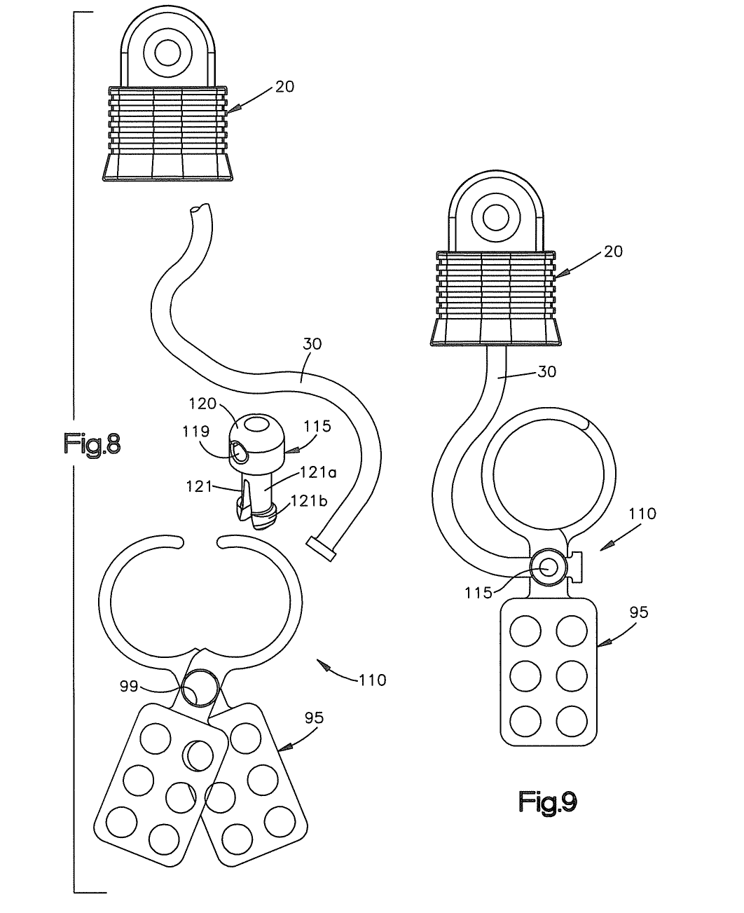

FIGS. 1a and 8-9 illustrate an exemplary lanyard 10 that is adapted to secure a lock mechanism such as a padlock or hasp with a lock mechanism coupler 115. The lock mechanism coupler 115 is adapted to snap fit into an appropriately sized mounting orifice in the lock mechanism. In FIGS. 1A and 8-9 the lock mechanism is a hasp 95 with a mounting orifice 99. The lock mechanism coupler 115 has a tether passage 119 through which a lead end 30a of the tether may be inserted. The tether passage is sized to prevent or greatly impede passage of the tether head 32 through the lock mechanism coupler 115. As can be seen in FIG. 1A, the lead end of the tether is passed through the tether passage 119 and then inserted into the catch 20. As described above, the tether is pulled through the catch until the desired tether length is achieved. The tether 30 may be trimmed to size and then the catch 20 can be installed in the desired location.

The lock mechanism coupler 115 includes two legs 121, each having a smaller diameter stem portion 121a and a flared head portion 121b at a distal end of the stem portion. To install the lock mechanism coupler on the tether, the flared head portions 121b are inserted into the mounting orifice 99. The flared head portions 121b are urged toward one another by the mounting orifice 99 until the stem portions 121a are within the hole. Once the stem portions are in the mounting orifice, the legs 121 snap back to substantially their original position relative one another and the coupler is retained in the mounting orifice 99 by the flared portions 121b. FIG. 9 shows the completed lanyard assembly with the tether 30 installed in the catch 20 and the lock mechanism coupler 115.

FIGS. 4-6 illustrate tether retaining features of the catch 20 in more detail. The molded catch housing 22 includes a clip cavity 74 that intersects the inner channel 26. A tether retaining clip 70 is inserted into the cavity 74 such that it protrudes into the cavity to engage the tether as shown in the cross section in FIG. 5. Referring to FIG. 6, the clip 70 includes a central portion 75, a base portion 76, and a forked portion 78 that is sized to closely surround the tether 30. The clip is bent at the central portion such that the base portion 75 is positioned at a bend angle a with respect to the forked portion. The clip 70 is formed from, for example, spring steel and is configured to flex to present a smaller bend angle θ relative to α. When the tether 30 is inserted into the channel 26 in the direction indicated by the arrows in FIG. 2C, the force of the tether on an underside of the clip 70b urges the forked portion toward the base portion to further compress the bend angle and the tether slides past the clip. When the tether 30 is pulled in the other direction, the forked portion is urged away from the base portion by friction between the tether and an upper surface 70a of the clip. The forked portion thus presses harder into the tether and retains the tether in position. In this manner, the tether may be installed in the catch and the length of tether extending beyond the catch can be shortened to an acceptable length, leaving the tether in a secured position such that the lanyard is ready for use to secure a lock member in proximity to a lock receiving interface.

While several embodiments of the invention has been illustrated and described in considerable detail, the present invention is not to be considered limited to the precise constructions disclosed. Various adaptations, modifications and uses of the invention may occur to those skilled in the arts to which the invention relates. It is the intention to cover all such adaptations, modifications and uses falling within the scope or spirit of the claims filed herewith.

I claim:

1. An apparatus that secures a lock mechanism to a surface, the lock mechanism including a mounting orifice, the apparatus comprising:
a flexible tether;
a catch comprising a tether retention mechanism that selectively retains the tether in fixed position with respect to the catch and a mounting mechanism configured to secure the catch to the surface; and
a coupler configured to snap fit into the mounting orifice to hold the lock mechanism on the tether.

2. The apparatus of claim 1 wherein the tether includes a tether head at a first distal end.

3. The apparatus of claim 1 wherein the tether is molded of plastic.

4. The apparatus of claim 1 wherein the mounting mechanism comprises a mounting ear having a hole through which a faster may be inserted.

5. The apparatus of claim 1 wherein the catch includes an inner channel through which the tether may be threaded.

6. The apparatus of claim 5 wherein the catch includes a tether retention clip having a notched end that is configured to engage the tether, the clip protruding into the inner channel to frictionally engage the tether.

7. The apparatus of claim 6 wherein the tether retention clip comprises a relatively thin metal spring having a top and bottom surface and including the notched end at a first distal end, a base portion at an opposing end, and a bent portion that positions the base portion at a bending angle less than 90 degrees with respect to the top surface of the notched end.

8. The apparatus of claim 6 wherein the tether retention clip is installed in the catch such that the bottom surface of the notched end confronts the tether along its length at the bending angle so that the clip permits motion of the tether toward the bottom surface of the clip and impedes motion of the tether toward the top surface of the clip.

9. The apparatus of claim 6 wherein the notched end comprises a bifurcated fork that has an inner surface configured to closely surround a partial periphery of the tether.

10. The apparatus of claim 1 wherein the coupler comprises a head and a pair of legs extending from a bottom surface of the head, each leg including an outwardly flared portion disposed at a distal end of a stem portion, the stem portion being adjacent the bottom surface.

11. The apparatus of claim 2 wherein the coupler includes a tether passage sized to permit passage of the tether while impeding passage of the tether head.

12. A method that maintains a lock mechanism in proximity to a lock receiving interface comprising:
snap fitting a coupler into a mounting orifice in the lock mechanism;
connecting the coupler to a tether;
retaining the tether with a catch;
mounting the catch to a surface that is proximately located to the lock receiving interface.

13. The method of claim 14 wherein the step of connecting the coupler to the tether is performed by threading a first distal end of the tether through a hole in the coupler that is sized to permit passage of the tether but not a tether head at a second distal end of the tether.

14. The method of claim 12 wherein the step of snap fitting a lock mechanism coupler into the mounting orifice is performed by pressing flared end portions of a pair of coupler legs through the mounting orifice and engaging the orifice with stem portions of the coupler legs.

15. The method of claim 12 wherein the step of retaining the tether with a catch is performed by inserting the tether into an inner channel in the catch and retaining the tether with a clip that permits motion of the tether in one direction but impedes motion of the tether in an opposing direction.

16. The method of claim 12 comprising the step of adjusting the length of the tether.

17. The method of claim 16 wherein the step of adjusting the length is performed by severing an excess portion of the tether from a portion that is connected to the lock mechanism.

18. The method of claim 12 wherein the step of mounting the catch to a surface is performed by threading a fastener through a fastener receiving hole in the catch and securing the fastener to the surface.

19. An apparatus that secures a lock mechanism to a surface comprising:
a flexible tether;
a catch comprising:
a mounting mechanism configured to secure the catch to the surface;
an inner channel through which the tether may be threaded;
a tether retention clip that is configured to engage the tether, the clip protruding into the inner channel to frictionally engage the tether and selectively retain the tether in fixed position with respect to the catch; and
a coupler configured to snap fit into a mounting orifice in the lock mechanism.

20. The apparatus of claim 19 wherein the mounting mechanism comprises a mounting ear having a hole through which a fastener may be inserted.

21. The apparatus of claim 19 wherein the tether retention clip comprises a relatively thin metal spring having a top and bottom surface and including a notched end at a first distal end, a base portion at an opposing end, and a bent portion that positions the base portion at a bending angle less than 90 degrees with respect to the top surface of the notched end.

22. The apparatus of claim 21 wherein the tether retention clip is installed in the catch such that the bottom surface of the notched end confronts the tether along its length at the bending angle so that the clip permits motion of the tether toward the bottom surface of the clip and impedes motion of the tether toward the top surface of the clip.

23. The apparatus of claim 21 wherein the notched end comprises a bifurcated fork that has an inner surface configured to closely surround a partial periphery of the tether.

24. The apparatus of claim 19 wherein the coupler comprises a head and a pair of legs extending from a bottom surface of the head, each leg including an outwardly flared portion disposed at a distal end of a stem portion, the stem portion being adjacent the bottom surface, the legs being sized such that the flared portions at least partially define an outer diameter larger than an inner diameter of the mounting orifice and the stem portions include an outer diameter smaller than an inner diameter of the mounting orifice.
